(19) United States
(12) Patent Application Publication
(10) Pub. No.: US 2011/0083768 A1
(43) Pub. Date: Apr. 14, 2011

(54) METHODS, SYSTEMS, AND KITS FOR SHIPPING AND/OR OFF-LOADING GRANULAR PRODUCTS

(75) Inventors: David M. Sims, Houston, TX (US); Nancy Wendrock, Houston, TX (US)

(73) Assignee: Environmental Packaging Technologies Limited, Houston, TX (US)

(21) Appl. No.: 12/576,684

(22) Filed: Oct. 9, 2009

(51) Int. Cl. B65B 1/04; B67D 7/00; B65D 30/00

(52) U.S. Cl. 141/2; 222/1; 222/92; 222/105

(57) ABSTRACT

The application relates to shipping and off-loading of a granular, powdered, or other particulate materials using flexible containers, where the product tends to partially or fully consolidate during loading and/or shipping, therefore making off-loading problematic. One method includes loading a granular product into a flexible container, shipping the product-loaded flexible container to an end user or intermediate storage facility, and off-loading the granular product from the flexible container. The off-loading includes fluidly connecting a fluid supply conduit to the flexible container, commencing flow of fluid into the flexible container, forming a slurry of at least a portion the granular product and the fluid, and routing the slurry out of the flexible container through a slurry off-loading conduit. In some instances the methods include heating the fluid before and/or during its flow into the flexible container.

### BACKGROUND

1. Field of the Invention

The field of the invention(s) claimed below relates to shipping and off-loading of granular, powdered, or other particulate materials using flexible containers.

2. Description of Related Art

As noted above, the particular type of container to which this application is directed is one that includes a large single or multi-layered flexible container, such as that known under the trade designation “BIG RED FLEXITANK®”, available from Environmental Packaging Technologies, Ltd., assignee of the present patent. In actual use during shipping, the flexible containers are frequently used in combination with a large, box-shaped, rigid shipping container. When assembling these types of shipping apparatus, the initially-empty flexible container is placed inside the rigid container. Typically, reinforcing bars and a woven sheet are then installed to form a barrier between the flexible container and the open end of the rigid container, which also functions as a barrier after the container doors are closed. The installation of the woven sheet typically includes strapping it in place. Cargo, such as liquid or granular material, is then introduced to the inside of the flexible container, typically through a discharge or inlet valve. After the flexible container is filled, the container door(s) are rotated to a closed position. The resulting apparatus is primarily used to transport the cargo for great distances, typically over water, on barges or other types of oceangoing vessels, and also sometimes over land by railway.

Shipping container apparatus having a flexible container placed inside a rigid container have been used before, including several that are identified in one or more patents appearing on the face of this patent. Many of those types of shipping container apparatus in use today suffer from various shortcomings when shipping and/or off-loading granular or similar products. One problem is that many granular and similar products are subject to clumping, melting, congealing, and/or otherwise wholly or partially transforming into a consolidated mass inside the flexible container during shipping. This may be due to high humidity, high or low temperatures, or changes in these parameters during transport time, all or some of which can have a synergistic effect on consolidation of the granular products. The process of consolidating into a partial or whole solid mass may actually begin shortly after loading, or even during loading, depending on the size of the flexible container, the time it takes to completely fill a large flexible container, and environmental conditions during loading. Another factor is the treatment of the materials prior to loading into flexible containers. As an example, the refining process used to refine granular and/or powdered sugar, and the storage in silos or other containers, may affect the tendency of the materials to consolidate in the flexible shipping container, and/or the degree of consolidation in the flexible shipping container.

This shortcoming of partial or wholly consolidation of granular products into a solid mass inside the flexible container leads to another shortcoming, that being the difficulty of off-loading such items after they have been shipped to their intended destination. Even if the materials are carefully handled prior to loading, and care is taken to properly load the flexible container, the subsequent off-loading may be a labor-intensive, time-intensive operation due to consolidation of the product, which is detrimental to good business for a number of reasons. Another shortcoming is that the solidification or consolidation may actually negatively affect the structural integrity of the flexible container, leading to shorter life, or making a repair necessary. If the flexible container is subsequently used to ship a liquid product, undue leakage of liquid cargo from the flexible container may be exaggerated. This leakage occurs in various places in the flexible container and for various reasons. Leakage may occur in the vicinity of one of the valves, e.g., the discharge valve, or through a hole in the flexible material comprising the flexible container.

There have been various systems and methods proposed in the flexible container art to off-load fluids, but each has shortcomings, and none to the inventors' knowledge recognizes the problem of consolidation of solids after loading of solid, granular or particulate materials into such a flexible container, nor do they recognize the subsequent problem of how to efficiently and safely remove such consolidated materials from such flexible containers, and therefore no one has proposed a solution to this unique problem, even though once these problems have been identified, their solution may become apparent. In the medical field, U.S. Pat. No. 4,722,727 discloses a flexible container used for peritoneal dialysis which has a port with a plug disposed in the port. Extending from the port in the flexible container is a length of flexible tubing. One end of the plug is located within the end of the flexible tubing connected to and extending from the port of the flexible container. The other end of the plug extends into the flexible container itself. To dispense dialysate fluid from the flexible container, the end of the plug extending into the flexible container must be grasped between the flexible sides of the container. By manipulating the end of the plug extending into the flexible container, the end of the plug which seals the short piece of flexible tubing can be unseated. Fluid is thereby allowed to pass from within the flexible container, through the port and through tubing to the peritoneum of the patient. This type of flexible container, port, and plug is, however, impractical for use in shipping and off-loading granular solid materials, especially in bulk, as it would be difficult to compress a flexible container of bulk size, and even if it could be done, the solidified mass of granular materials encroaching on the inside of the flexible material of the container could damage the material, leading to leakage.

U.S. Pat. Nos. 4,136,713 and 4,223,709 disclose flexible containers used for bulk shipping having various lifting loops and belts for supporting the containers when off-loading. Neither of these references recognizes any problem with off-loading consolidated granular or particulate materials. U.S. Pat. No. 3,586,066 discloses methods of filling flexible containers with finely divided materials. The container is filled with product and a pressurized gas, followed by exerting a vacuum on the internal portion of the container. Since the pressurized gas creates a pressure above atmospheric pressure, the subsequent application of vacuum deters the container from collapsing. Published U.S. Pat. App. Nos. 20080118187, 20080173373, and U.S. Pat. Nos. 6,626,212 and 6,913,028 disclose flexible containers, but do not recognize any problem with off-loading granular or particulate materials or products that have consolidated during loading and/or shipment.

It would be advantageous if systems and methods could be developed that safely and efficiently allow granular, particulate, and/or finely divided materials and products to be loaded into flexible containers, transported, and off-loaded subsequent to the materials consolidating during loading and/or transport. The systems and methods of the present disclosure are directed to these needs.

### SUMMARY

One method of this disclosure is a method of shipping and off-loading a granular product, comprising:
a) loading a granular product into a flexible container, the flexible container positioned inside of a shipping container, the flexible container comprising at least one product inlet, at least one fluid inlet, and at least one slurry outlet for slurried granular product, the flexible container comprising at least one expandable material and at least one containment material;
b) shipping the product-loaded flexible container to an end user or intermediate storage facility using the shipping container; and
c) off-loading the granular product from the product-loaded flexible container, wherein the off-loading comprises fluidly connecting a source of fluid to the at least one fluid inlet using a fluid supply conduit, commencing flow of fluid into the flexible container, forming a slurry comprised of at least a portion the granular product and the fluid, and routing the slurry out of the flexible container through a slurry off-loading conduit.

In certain method embodiments the fluid may be aqueous or non-aqueous. As used herein “substantially water” means that the fluid is 75 percent water or higher.

In certain method embodiments the container is prevented or deterred from collapsing during off-loading. Means for preventing and/or deterring collapse may be selected from snaps, loops, hook and loop fasteners, and the like, securely attached to the outside of the flexible container.

Certain method embodiments comprise controlling storage conditions of the granular product prior to loading into the flexible container, and/or controlling processing of the granular product prior to loading into the flexible container. For example, if the granular product is sugar, powdered or granulated, the sugar may be refined in a way that substantially reduces consolidation of the sugar once loaded into the flexible container.

Certain methods of the disclosure include connecting conduits to the flexible container using quick-connect/quick disconnect connectors, sometimes referred to as cam-locks in the art.

In certain method embodiments, warming the fluid prior to and/or during flow of fluid into the flexible container may enhance the ability of the fluid to slurry the granular product.

In certain methods it may be advantageous to dose the flow of fluid into the flexible container, which may create more turbulence and help slurry the granular product in the flexible container.

Another aspect of the disclosure is a method of off-loading a granular product from a flexible container, comprising:
a) fluidly connecting a source of fluid to a flexible container having granular product therein, the flexible container having at least one fluid inlet connection;
b) fluidly connecting a destination for slurried granular product to the flexible container, the flexible container having at least one slurry outlet; and
c) commencing flow of fluid into the flexible container and allowing slurried granular product to controllably flow out of the flexible container through the slurry outlet to the destination.

Another aspect of the disclosure is a system or kit for shipping and off-loading granular products, the system comprising:
a) a flexible container comprising at least one granular product inlet, at least one fluid inlet, and at least one slurry outlet;
b) first and second conduits, the first conduit routing a fluid into the flexible container and positioned to slurry the granular product after reaching an off-loading point, the second conduit routing slurried granular product out of the flexible container during off-loading; and
c) means for deterring collapse of the flexible container during off-loading of the slurried granular product.

Useful flexible containers for use in the systems and methods of this disclosure include “substantially seemless” flexible containers, as well as more conventional seemed flexible containers. As used herein the phrase “substantially seemless” means that the flexible container is formed from a tube of flexible material and has at most two seems, one on each end of the tube as further illustrated and explained herein.

The systems or kits disclosed herein may include means for deterring collapse, wherein the means may be fasteners selected from one or more snaps, loops, hook and loop fasteners, and combinations thereof, securely attached to an external surface of the flexible container in a fashion so that the fasteners are able to engage in a cooperative, supporting fashion with a rigid container into which the flexible container has been placed, thereby substantially deterring collapse of the flexible container.

These and other features of the systems and methods of the disclosure will become more apparent upon review of the brief description of the drawings, the detailed description, and the claims that follow.

### BRIEF DESCRIPTION OF THE DRAWINGS

The manner in which the objectives of this disclosure and other desirable characteristics can be obtained is explained in the following description and attached drawings in which:

FIG. 1 is a schematic perspective view of one flexible container system in accordance with the present disclosure;

FIGS. 2-4 are schematic cross-sectional views of three different embodiments of fluid inlet connections useful in practicing the systems and methods described herein;

FIGS. 5 and 6 are schematic side-elevation views, partially cut away, of two other embodiments of flexible containers useful in the systems and methods of the present disclosure;

FIG. 7 is a schematic perspective view of another flexible container system in accordance with the present disclosure;

FIG. 8 illustrates an exploded perspective view of a combination in accordance with this disclosure, featuring a flexible container disposed within a rigid container; and

FIG. 9 illustrates a logic diagram of one method within the disclosure.

It is to be noted, however, that the appended drawings are not to scale and illustrate only typical embodiments of this disclosure, and are therefore not to be considered limiting of its scope, for the systems and methods of the disclosure may admit to other equally effective embodiments. Identical reference numerals are used throughout the several views for like or similar elements.

### DETAILED DESCRIPTION

In the following description, numerous details are set forth to provide an understanding of the disclosed methods and apparatus. However, it will be understood by those skilled in the art that the methods and systems may be practiced without these details and that numerous variations or modifications from the described embodiments may be possible.

All phrases, derivations, collocations and multiword expressions used herein, in particular in the claims that follow, are expressly not limited to nouns and verbs. It is apparent that meanings are not just expressed by nouns and verbs or single words. Languages use a variety of ways to express content. The existence of inventive concepts and the ways in which these are expressed varies in language-cultures. For example, many lexicalized compounds in Germanic languages are often expressed as adjective-noun combinations, noun-preposition-noun combinations or derivations in Romantic languages. The possibility to include phrases, derivations and collocations in the claims is essential for high-quality patents, making it possible to reduce expressions to their conceptual content, and all possible conceptual combinations of words that are compatible with such content (either within a language or across languages) are intended to be included in the used phrases.

“Slurry” as used herein means a combination of a fluid with a granular material.

“Fluid” as used herein may be exclusively one or more miscible or immiscible liquids; or one or more miscible or immiscible liquids combined with one or more gases, such as a gas dissolved or partially dissolved in a one or more liquids, or in certain embodiments a gas, mixture of gases, or a vapor or mixture of gas and vapor, such as a mixture of steam and air (humid air) that has heat content and flow volume sufficient to melt or vaporize a solidified mass of granular material in order that the granular material may be removed from the flexible container.

The term “fluid” includes emulsions, both oil-in-water and water-in oil emulsions. The fluid itself could indeed be a slurry, especially if the fluid to be used to slurry the product in the flexible container would benefit from being more easily slurried if the fluid had solid particles in it. For example, the fluid could in some embodiments at first be a less concentrated version of the slurry being off-loaded from the flexible container, and as off-loading progressed, the fluid could become a more concentrated version of the slurry being off-loaded. At some point, the slurry being off-loaded will actually more resemble the fluid being added to the flexible container, an indication that the flexible container has been emptied of its granular product.

“Granular material” includes, but is not limited to, powders, dusts, granules, particulates, particles, beans (for example coffee beans, soy beans, and the like), beads (such as catalyst beads, and polymer resin beads), pellets (such as fertilizer pellets, and the like). Granular materials may be random or non-random in particle size and shape. For example, the granular material may be sugar granules that are substantially non-random in shape and size. The shape may include, but not be limited to, square, horns, saddles, spheres, hemispheres, cones, any and all polyhedral shapes, and the like. The granular material may in certain embodiments have a particle size distribution which may be advantageous for removal from flexible container after being contacted by a fluid. In general, the only upper limitation on size of the granular material is that it be small enough to fit (flow through) an exit connection in the flexible container so that it may be off-loaded therefrom without significant clogging (although some temporary and/or intermittent clogging may be tolerated). Granular materials may be the result of spray drying.

A list of specific combinations of fluid and granular products might include, but are not limited to: water and granulated sugar; water and powdered sugar; water and any dehydrated food (for example dehydrated fruits and vegetables); water and ground coffee; water and green coffee beans; water and rice; methylene chloride and coffee beans; ethyl acetate and coffee beans; water and fertilizer pellets; water and tea leaves; water and powdered drink mix (such as powdered sports drinks); and the like. In these examples the water may or may not be 100 percent water. In other words, “water” may be an aqueous combination of water and one or more additives. The additives may be organic or inorganic in nature.

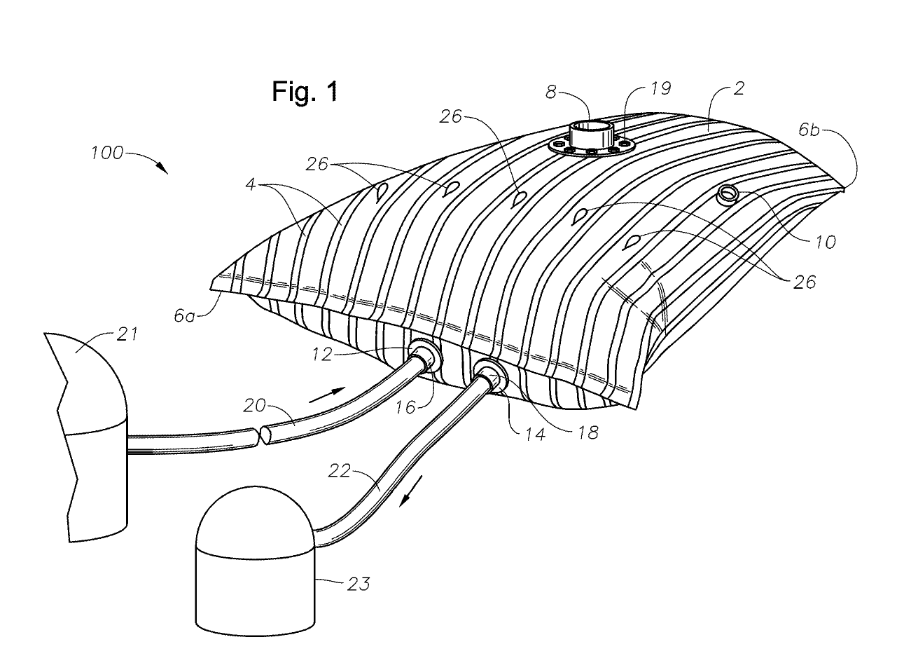

Certain claims herein include a reference to a “flexible container.” As used herein, a “flexible container” is defined as any flexible structure having a length and width, inner surface(s), outer surface(s), an interior (inside) capable of holding liquids or flowable solids (or solids consolidated into one or more solid mass that is/are capable of being made flowable as a slurry, as taught herein), one or more openings through which fluid is capable of passing into or from the inside of the flexible container, and one or more openings through which slurried granular product is capable of passing from the inside of the flexible container. There are many different sizes and types (embodiments) of flexible containers, e.g., different categories and/or subcategories of flexible containers. For example, different types of flexible containers may have or include different sizes, shapes, materials and components (.e.g., fixtures and/or hardware, including fittings). Thus, unless specified otherwise, or unless apparent from the context, all references herein to a “flexible container” encompass any and all of the many different types of flexible containers, modified as taught herein to off-load slurried granular products. The flexible material component of the flexible container can be, for example, a single-layered bag or a multi-layered bag. The flexible container can also be a combination of bags or layers or liners in which one or more bags or layers or liners are disposed inside of one or more other bags or layers or liners (discussed below). Alternatively, the flexible container can be a laminated bag, comprising different layers laminated together. As discussed herein, the inner surface of the flexible material defines the inside of the flexible container (e.g., an inner cavity). Unless specified otherwise, in an embodiment of the flexible container in which one or more bags are disposed inside of one or more other bags, the “outer surface” of the flexible container refers to the outermost surface of the outermost bag or layer, while the “inner surface” of the flexible container refers to the innermost surface of the innermost bag or layer, which surface is designed for, or capable of, contact with the cargo, e.g., the liquid or solids that are being contained or held by the flexible container. Thus, for example, a multi-layer flexible container may have one or more intermediate layer(s) that is/are sandwiched between 2 other layers, which intermediate layer(s) provide(s) neither an outer flexible container surface nor an inner flexible container surface. The outer surface of the flexible material defines the outside of the flexible container. The flexible container is necessarily capable of holding (containing) any of a variety of flowable materials, such as any liquid (such as wine), or a slurry or granular solid particles (e.g., coffee beans or rice). The flexible container can be in a filled (partially filled, substantially filled, or totally filled) state (condition), for example, if liquid occupies the inside of the flexible container. Alternatively, the flexible container can be in an empty (unfilled) state (condition). As discussed below, the flexible container includes not only the flexible part (e.g., the bags) but also at least one opening. The flexible container that includes separate independent layers in certain embodiments also includes at least a fitting corresponding to at least one opening, which fitting can include one or more flanges or any mechanical fitting that clamps the layers together around the opening. The flexible container is in certain embodiments “elongated” which, as used herein, means that the flexible container has a length and a width, with sides that define the length (e.g., opposing sides) that are longer than the ends (e.g., opposing ends) which define the width. In certain embodiments, the flexible container is seamless along its length and can be formed from multiple tubes, as discussed in the '982 application, discussed below. When the flexible container is empty and is lying flat on the ground or other horizontal surface (e.g., the inside floor of a rigid shipping container), the flexible container is in certain embodiments rectangular. In the rectangular embodiment, the two length-wise sides of the rectangle are parallel to one another; and the two ends of the rectangle are also parallel to one another. When the flexible container is filled (substantially or totally), it has a length and a width, and also has a height. When the flexible container is filled, in certain embodiments it has an oblong shape. For example, a flexible container that is substantially or totally filled can be pillow-shaped, as shown in certain drawings herein. The flexible container has an overall size, including all its dimensions, such that it is capable of fitting into a rigid shipping container, both in an empty state and in a filled state. For example, a flexible container can have a length of from 5, or 15, or 20 feet, to 30, or 50, or 60 feet. That flexible container can have a width of from 3, or 4, or 5 feet to 6, or 8, or 12 feet. The flexible container can have a height (when filled) of from 1, or 2, or 3 feet to 4, or 7, or 10 feet. The flexible containers have dimensions (length, width and height) such that, in both an empty and filled condition, they can fit inside of whatever rigid container they are used with. They can have a volumetric capacity ranging anywhere from 5,000 liters to 30,000 liters. The flexible container can have a plurality of different components, including the bags or sheets of which the flexible container is made. For example, as noted above, certain flexible containers include a combination of bags (sometimes also referred to as “bladders”), in which bags are disposed within other bags. Certain examples of a flexible container are disclosed in U.S. Ser. No. 11/124,982, Publication No. US 2006/0251343 (“982 application”). All the parts of that application referring to “flexible multi-layer containers,” and the manner of making them, are hereby incorporated by reference, including the flanges and fittings, are also incorporated by reference. Specifically, the parts of Publication No. US 2006/0251343 that are incorporated herein by reference are FIGS. 1-20 and paragraphs [0031]-[0060].

The flexible container may also have one or more openings (apertures) in the flexible material itself by which air or cargo (liquid or granular) can be introduced to, or discharged from, the inside of the flexible container. Examples of such openings include a main or primary granular product input opening, a secondary granular product opening, one or more fluid inlet openings, one or more slurry discharge openings, and/or one or more vent openings. Other components are structures associated with each of the openings such as, for example: a discharge valve, for example a ball valve with a handle that is capable of being rotated from a closed position to an open position, or other kind of valves such as gate valves; check valves for allowing flow of fluid or slurry in one direction but not another; one or more fittings for one or more discharge valves that may include one or more flanges; one or more vent lines associated with a vent opening for releasing air or other gas from the inside of the flexible container; and one or more fittings for the vent lines that may include one or more flanges. Examples of fittings are disclosed in the '982 application referenced above. Any flexible container referenced herein may include at least one independent inner layer (e.g., an inner bag or liner) that is disposed inside another independent layer (e.g., an intermediate bag or liner), which is disposed inside yet another independent layer (e.g., an outer bag or liner). Those three layers can be regarded as three independent bags (e.g., bladders) combined to form a single composite bag. Examples of a flexible container that includes a combination of three bags, layers or liners are disclosed in the '982 application referenced above. Materials of construction of fittings, openings, valves, and conduits are largely dictated by the fluids and slurries expected to be handled, shipped, and/or off-loaded, as well as temperature and pressures expected in the systems. Polycarbonate and stainless steel have been used with success for most fluids and slurries.

Certain claims may include the term “container,” without being modified by the word “flexible.” As used herein, the term “container” when used without the modifier “flexible” refers to a rigid container, exemplified by the container 112 depicted in the drawings. The term “container” as used herein (rigid container) is defined as any rigid, metal box-like structure having two opposing vertically disposed side walls that have a length of at least 10 feet and in certain embodiments up to 60 feet; a height of at least 6 feet and in certain embodiments up to 12 feet; and a width (corresponding generally to the space between the two opposing side walls) of at least 6 feet and in certain embodiments up to 12 feet. The container also has a floor that has substantially the same length as the two side walls, and one end wall that is disposed between the side walls at the end of the container, which shall be referred to herein as the “rear wall” (also called the “closed end wall,” or the “closed end” or the “end wall”) of the container. The container also has an end opposite the closed end, which end shall be referred to herein as the “front end” or “open end” of the container. The container has one or more doors, which are flat members positioned at or proximate the open end that are capable of swinging open or closed. At least one embodiment of the container also has a top member, or “lid,” which is used to secure the flexible container inside the container during transportation (shipping). In certain embodiments, the lid is formed of a grating with bars that are formed in crisscross arrangement. Each of the side walls, and the rear wall, has an inside (inner) surface, and an outside (outer) surface. As shown in certain drawings herein, each container has an overall inside surface, which is irregular or corrugated (sometimes referred to as having “lazy” corrugations) but is nevertheless considered “substantially planar” as that term is used herein. As discussed in greater detail below, the overall surface of each of the rigid container walls has sub-surfaces (on the inside and outside of the container), which are discussed in greater detail herein and are also themselves referred to as “surfaces.” Also, for clarification, when reference is made herein to any container that has flexible walls, that container will be referred to either as a flexible container or a “flexible container,” or in certain instances that container will be referred to as a “sleeve.”

Any rigid “container” referenced herein is intended to include both a shipping container and truck trailer container. That is, the shipping container and the truck trailer container each qualify as a “container” as defined above. For example, each of them has a structure with the dimensions referenced above. The term shipping container (also called a “cargo container”) is well-known to persons involved in the shipping industry. The shipping container is capable of being used to ship (transport) large quantities of cargo over long distances, typically over water, on ships or barges, or over land on railway cars. A truck trailer container, on the other hand, is a container that also includes a chassis, and wheels, and a structure for attaching chassis to any truck having a diesel engine.

Various specific embodiments disclosed herein include at least one novel type of bulkhead assembly. As used herein, the term “bulkhead assembly” itself broadly means any structure disposed between a filled flexible container that is located inside the rigid container and the inside surface of either or both of the container doors, when they are closed, or the front end of the container when the container doors are open. There are various types of bulkhead assemblies. Certain bulkhead assemblies that have been used in the past include blocking structures which include a rectangular structure placed on the floor of the container between the flexible container and the inside of the container door(s), which structure includes an opening through which a discharge valve member can protrude, and which structure includes bolts that fit into the rigid container lashing channels. Another type of bulkhead assembly includes reinforcing cross-bars which are positioned horizontally and/or vertically to separate the filled flexible container from the inner surface of the door(s), and to thus restrain the flexible container. Bulkhead assemblies can also include a flexible sheet, e.g., a tarp that is tied to the cross-bars and/or to struts that are an integral part of the container. Although those types of bulkhead assemblies, which have been used in the past, can be used as part of certain embodiments discussed below, certain embodiments of shipping container apparatus include the bulkhead assemblies as disclosed in some detail below, an in greater detail in assignee's non-provisional U.S. patent application Ser. No. 12/______, filed Nov. ______, 2009, claiming priority from provisional patent application Ser. No. 61/115,794, filed Nov. 18, 2008, and Ser. No. 61/215,706, filed May 8, 2009.

At least one specific embodiment of a shipping container apparatus disclosed herein includes a sleeve. As used herein, the term “sleeve” is itself broadly defined to mean any flexible structure that can be placed inside a rigid container to provide a barrier between the outer surface of the flexible container and inner walls of the container, and has at least a floor with two opposing side walls (panels) and a rear wall (panel). In one or more specific embodiments, the sleeve is a flexible abrasion vapor containment structure. Such a structure is flexible and also serves to protect the flexible container from experiencing abrasion, which has the potential for leakage. Such a structure also prevents vapor from passing through the layer(s) of the sleeve by virtue of including a layer that is vapor-impermeable. The sleeve fits into a rigid container, and is sized accordingly. The sleeve is, certain embodiments, open at the top, so that the top surface of the flexible container can be viewed during shipment. The term “sleeve” is itself not restricted to any particular shape, size, or material. As discussed below, at least one version of the sleeve is box-like in shape, and has a horizontally disposed floor and four vertical walls (panels) configured to fit on the inside of a rigid container (e.g., a shipping container). The boxlike version has creases along the four lower edges of the side walls (panels) where those side walls (panels) adjoin the flexible rectangular floor. As an alternative to the box-like version, at least one version of the wear-sleeve is rounded at the places where the floor of the sleeve adjoins the side walls (panels), such that, unlike the aforementioned box-like version, there is no crease between the floor and each side wall (panel) of the sleeve that separates the flexible container from the inside walls of the rigid container. The rounded version of the sleeve is thus more tube-like than box-like in shape. At least one version (embodiment) of the sleeve has a floor panel that, when placed into a rigid shipping container, is disposed horizontally on the container floor, and also has at least three flexible sleeve walls that, when the sleeve is placed into a rigid shipping container, are substantially vertically oriented so that the sleeve provides a barrier between the outer surface of the flexible container and inner walls of the container. In certain embodiments, the sleeve has at least four flexible walls (panels) that are vertically oriented, and all vertical walls (panels) are integrally attached along one edge to the sleeve floor. Other versions of the sleeve, and various aspects or features of those versions, are described below.

Referring now to the drawing figures, FIG. 1 is a schematic perspective view of one system embodiment 100 in accordance with the present disclosure, including a flexible material 2 illustrated in this embodiment as including strength-reinforcing weaves 4 (sometimes referred to as strength bands in the art). Flexible material 2 may have anywhere from 1 to 2, or from 1 to 4, or from 1 to 6, or even more layers. Two typical embodiments are 2-layer materials, one embodiment comprised of 2 14-mil layers of polyethylene, and the second comprised of one 14-mil ply or layer of EVOH (ethylene vinyl acetate) and one 14-mil layer of polyethylene. Other materials which may be employed include, but are not limited to those wherein one layer is selected from polymers including amorphous poly(ethylene terephthalate) (APET), polypropylene (PP), high-density poly (ethylene) (HDPE), poly(vinylchloride) (PVC), poly(styrene) PS, and mixtures, copolymers, combinations and layered versions thereof, wherein each layer may be a mixture or copolymer of two or more of these. The second layer may be a mono layer, a homopolymer or blends of polymers, or a coextruded film comprised of distinct multiple layers with homopolymer or blends of polymers within each layer. Polymers that may be used in the second layer may be selected from ethylene-vinyl acetate (EVOH), poly(ethyl)methacrylate (EMA), high-melt strength LDPEs, and metallocenes such as metallocene poly(ethylenes), also known as plastomer metallocene poly(ethylenes), low-density poly(ethylene) (LDPE), ultra-low density linear poly(ethylene) (ULLDPE), linear low density poly(ethylene) (LLDPE), K-resin, PP, poly(butadiene), and mixtures, copolymers, and layered versions of two or more of these, wherein each layer may be a mixture, copolymer, or some other combination of these polymers. As used herein the term “copolymer” includes not only those polymers having two different monomers reacted to form the polymer, but two or more monomers reacted to form the polymer.

The flexible material 2 may meet the standards as detailed in Table 1.

TABLE 1

| | | |
|---|---|---|
| Tensile Strength | ASTM D-882 | PE 68 ppi |
| | | EVOH 35 ppi |
| Peak Elongation MD | ASTM D-882 | PE 1000% |
| | | EVOH 655% |
| Puncture Resistance (lbs) | ASTM D-3420 | PE 4000 (dart) |
| | | EVOH 1500 (dart) |
| Oxygen Permeation | ASTM D-3985 | PE 20 cc/100 in2/day Max. |
| | | EVOH 0.027 cc/100 in2/ |
| | | day Max |
| Moisture Transfer (perms) | ASTM F-1249 | PE 0.03 |
| | | EVOH 0.05 |
| Effective Temperature | | 167° F. to −23° F. or |
| Range | | 75° C. to −5° C. |

An empirical measurement widely used to characterize controlled-atmosphere packaging materials is the oxygen transport (or oxygen transmission or oxygen permeation) rate. The oxygen transmission rate (OTR) of any given material is expressed as cc O₂/m²-day-atmosphere. Several related units of measure are also widely used in the field, such as cc O²/100 in²/mil thickness of film/24 hours. Another widely employed means of measuring OTR is described in ASTM D3985-81, which yields an OTR measurement having the units of cc O₂/100 in²/24 hours. (In ASTM D3985-81, the thickness of the film tested in not included in the units expressing the OTR.) The CO₂ transmission rate is also an important physical measurement in certain packaging films. The ratio between the CO₂ transmission rate and the OTR is designated the “beta value.”

As used herein, the phrase “gas-permeability” refers to the transport of gases such as oxygen, nitrogen and carbon dioxide across a membrane. Unless otherwise noted, “gas-permeability” refers to all gases in general.

“Oxygen transport (or transmission) rate (OTR)” as used herein designates oxygen transport rate as measured by ASTM D3985-81 or any equivalent protocol. See also ASTM F1307-02.

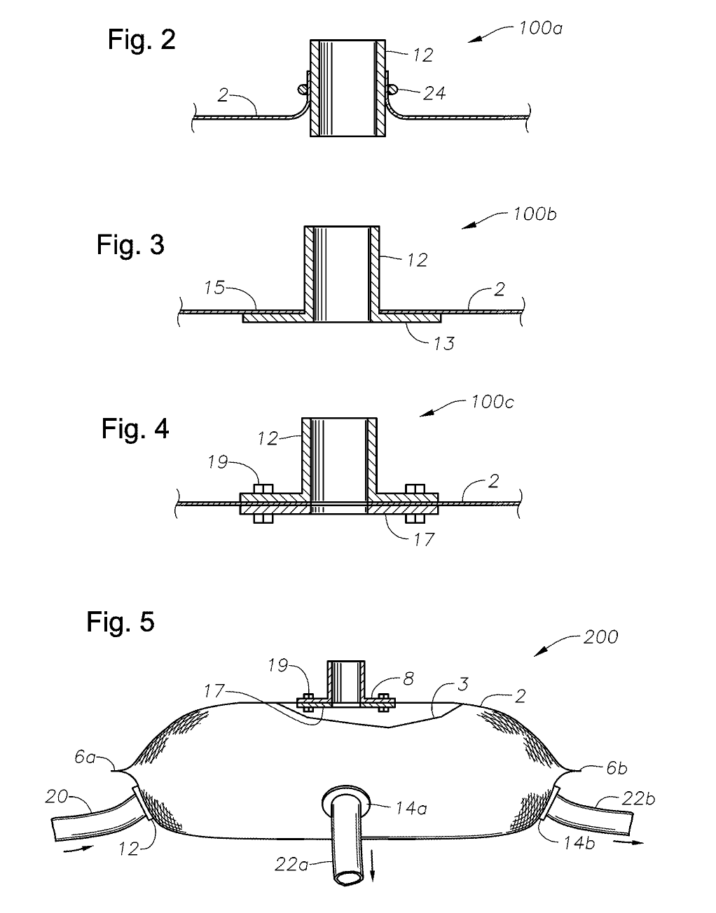

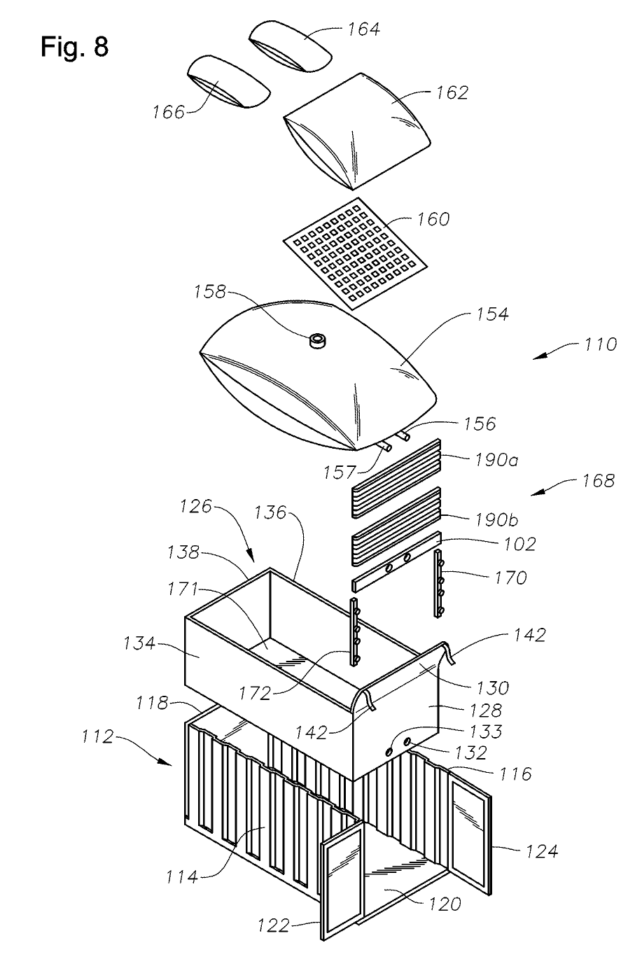

Referring again to FIG. 1, the flexible container of system embodiment 100 further includes a first seem 6a and a second seem 6b. Seems 6a and 6b would be placed parallel to the front and rear ends of a container when placed inside the carrier, as may be more fully appreciated referring to FIG. 8. A granular product inlet 8 is illustrated having the structure in this embodiment as depicted in cross-section in FIG. 4 for a suitable fluid inlet 12. FIGS. 1 and 4 illustrate a suitable fluid inlet 12 useful in the systems and methods of the disclosure, FIG. 4 being a vertical cross-section (embodiment 100c). In embodiment 100c of FIG. 4, the fluid inlet connection 12 is a compression flange type connection to the flexible material 2, where a spool piece 17 is positioned on the interior flexible container 100 and spool 17 and corresponding flange of fluid inlet connection 12 are bolted together using a plurality of bolts 19 in compression fit, having flexible material 2 in between, so that leaks cannot occur, or are at least reduced to a minimum. Suitable compression flange type connections include those disclosed in assignee's application Ser. No. 12/______, filed Nov. ______, 2009, claiming priority from provisional patent application Ser. No. 61/115,794, filed Nov. 18, 2008, and Ser. No. 61/215,706, filed May 8, 2009, previously incorporated herein by reference, having grooves in the facing of spool 17 facing the flange, and a raised edge region around each bolt hole, so as to minimize fluid leakage. Granular product inlet 8 has, in this embodiment, similar construction as fluid inlet 12, although this is not required. A slurry outlet connection 14 is also illustrated, and has similar construction in this embodiment to fluid inlet connection 12 and granular product inlet 8, although this is not required. Indeed, the construction of granular product inlet 8, fluid product inlet 12, and slurry outlet 14 may have the same or different constructions. Three conventional constructions useful in the practice of the methods and systems of the present disclosure are depicted in FIGS. 2, 3, and 4 in vertical cross-section. FIG. 2 illustrates a “clamped” connection in embodiment 100a, where flexible material 2 is gathered and clamped with a ring clamp 24. FIG. 3 illustrates an “integral” embodiment 100b, where the inlet connection body 12 and a flange 13 are molded of the same material, and then heat sealed or otherwise adhered to flexible material 2 in region 15 around inlet body 12.

FIG. 1 also illustrates a second granular product inlet 10, which may also serve as a gas vent during loading and off-loading, or may be used as to sample the granular product or slurry inside flexible container 2.

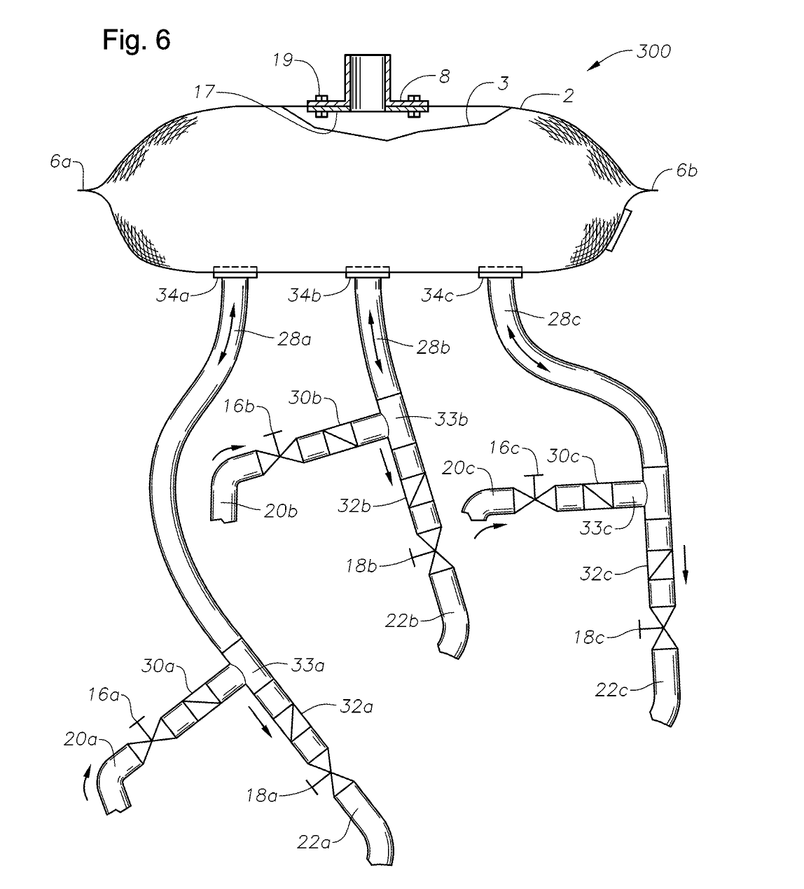

An important feature of the systems and methods of the present disclosure are the fluid inlet connection 12, a fluid inlet valve 16, a fluid inlet conduit 20, and a slurry outlet connection 14, slurry outlet valve 18, and slurry outlet conduit 22. It will be appreciated that embodiment 100 is a simplified drawing to illustrate the concept. Further details are discussed in reference to FIGS. 5, 6, 7 and 8, which are also merely examples. Illustrated in FIG. 1 is a fluid source 21 and a slurry destination 23. Generally, when off-loading flexible container 2 in accordance with conventional practice, when a consolidated mass of granular material is present inside flexible container 2, the only way to off-load the flexible container is to have personnel actual get inside of the flexible container and physically chip, scrape, or otherwise remove the material manually. This is of course very labor and time intensive, and presents safety concerns. This practice can also damage the flexible container 2. Certainly, a safer and more efficient system and method were desired. The systems and methods of the present disclosure use a fluid, as defined herein, flowing into the container to contact the mass of consolidated granular product, form a slurry or flowable solution of the (ordinarily) granular product, and flow the slurry or flowable solution out of the slurry outlet connection 14, valve 18, and conduit 22, into a destination tank, silo or end user facility, 23.

FIG. 1 also illustrates a plurality of fastening means 26 which may be used to deter or prevent flexible container 2 from collapsing on itself during off-loading. Suitable fastening means include snaps, loops, hook and loop fasteners, and equivalent structures. For example, illustrated in FIG. 1 are a plurality of loops 26, which may be used with straps, ropes, other tie-mechanisms internal to the shipping container to hold the flexible container up during off-loading operations.

FIGS. 5 and 6 are schematic side-elevation views of two other embodiments 200 and 300 of flexible containers useful in the systems and methods of the present disclosure, with part of the flexible container 2 cut away at 3 to show spool 17 for compression connection for granular product inlet 8. Embodiment 200 illustrates an embodiment wherein one fluid inlet 12 and fluid conduit 20 allow fluid to enter flexible container 2, while two slurry outlets 14a and 14b are provided, along with corresponding slurry conduits 22a and 22b. Source of fluid and destination of slurry are not depicted in embodiments 200 and 300 for clarity, but of course would also be present, as would various valves controlling flow of fluid and slurry as required, for example as in FIG. 6, embodiment 300. Embodiment 300 in FIG. 6 illustrates a system useful with certain products, where three connections 34a, 34b, and 34c are provided on the bottom of flexible container 2. It should be emphasized here and throughout this disclosure that the location of the fluid inlets and slurry outlets may vary while still being within the general teachings and concepts of the systems and methods of this disclosure. For example ion embodiment 300 of FIG. 6 the three connections 34a, 34b, and 34c could be positioned substantially next to each other on the front, underneath side of flexible container 2. In embodiment 300 each of connections 34a, 34b, and 34c is provided with corresponding conduits 28a, 28b, and 28c; corresponding fluid inlet conduits 20a, 20b, and 20c; corresponding slurry outlet conduits 22a, 22b, and 22c; corresponding tees 33a, 33b, and 33c; corresponding fluid inlet valves 16a, 16b, and 16c; and corresponding slurry outlet valves 18a, 18b, and 18c. Also provided are corresponding two-way conduits 28a, 28b, and 28c, as well as one way flow (check) valves 30a, 30b, and 30c in the fluid inlet lines 20a, 20b, and 20c, respectively, and corresponding one way flow valves 32a, 32b, and 32c in slurry outlet conduits 22a, 22b, and 22c, respectively.

The advantage of embodiment 300 of FIG. 6 is that the same connection on the flexible container may be used to both route fluid into, and slurried granular product out of, the flexible container. This embodiment also provides redundancy, should one connection clog or otherwise become inoperable, for example should check valve 30a malfunction, connections 34b and 34c could still operate in conjunction with their respective conduits and valves for supply of fluid and off-loading of slurried granular product. The specific arrangement illustrated in embodiment 300 of FIG. 6 also provides a spreading out effect of fluid entering flexible container 2, as well as multiple ports for off-loading of slurry.

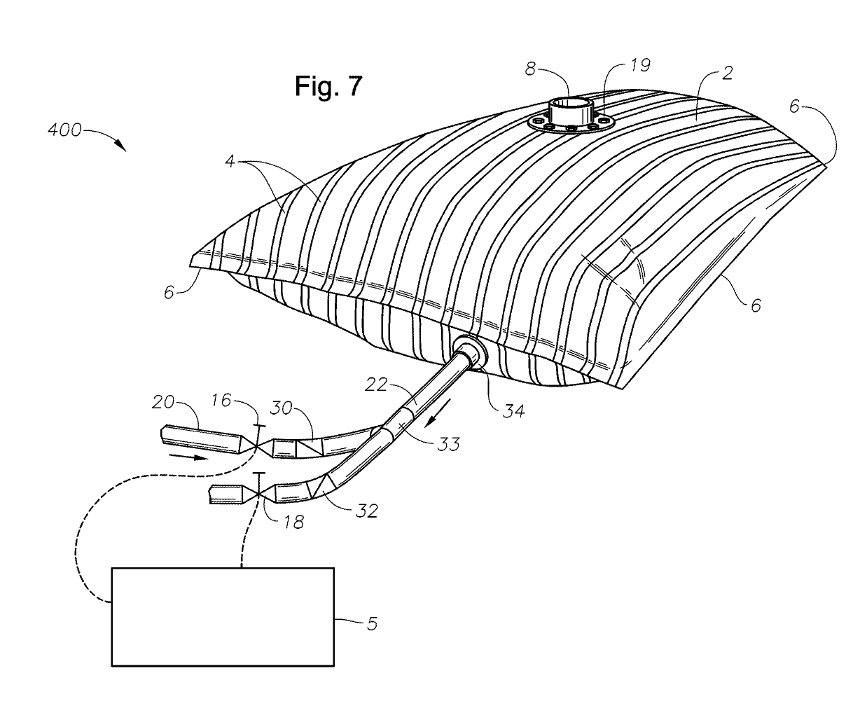

FIG. 7 is a schematic perspective view of another flexible container system embodiment 400 in accordance with the present disclosure, illustrating a system and method similar to that of embodiment 300 of FIG. 6, except that only a single two-way connection 34 is provided. While not providing the redundancy of embodiment 300, there is savings in hardware (valves, conduits), and less chance of leakage of slurry or fluid, as there are two fewer connections to the flexible container, all of which are potential leak sources. Embodiment 400 also differs from previously illustrated embodiments in that the flexible container has multiple seams 6, and illustrates a controller 5 for controlling flow rate of fluid and/or slurry.

Controller 5 is illustrated generically, as it may either represent human control, automatic control, such as by a programmed computer, or a combination of human and computer process control, for example, a human inputting set points and alarms into a process control computer. Automatic control maybe local or remote form the actual off-loading site. Other parameters may be monitored and/or controlled by the controller in conjunction with sensors, such as flow rates, temperatures and pressures of fluid and slurry, temperature and pressure inside the flexible container, viscosity, turbidity, color, rheology of fluid and/or slurry. Components for monitoring and/or control of these and other parameters that may be contemplated are known to the skilled artisan.

Embodiments 200, 300, and 400 show use of tees 33. It may be pointed out that certain embodiments may make use of one or more three-way valves in place of tees and valves in each conduit.

Flow rates, temperatures, pressures, and other properties of fluid and slurry may vary widely. Flow rate of fluid may range from a fraction of a gallon or liter per minute, up to 1000 gallons or 4000 liters per minute, or higher. The flow rate of slurry will follow, somewhat, the flow rate of fluid. For example, if a dosing flow of fluid is used, it would be expected that the slurry off-loading flow rate would be dosed as well, with somewhat higher mass flow rates than the fluid flow rate, owing to the fluid combining with the granular materials in the flexible container. The weight of the flexible container and contents may be closely monitored by placing the rigid container and accompanying flexible container on a scale. Knowing the tare weight of each, and knowledge of the weight or mass of granular product loaded into the flexible container, allows an operator to monitor and control the off-loading of slurried granular product.

FIG. 8 illustrates an exploded perspective view of a system (combination) embodiment 110 in accordance with this disclosure, featuring a flexible container disposed within a rigid container. The particular shipping container apparatus 110 illustrated in FIG. 8 includes a number of elements, components and/or features which are discussed herein. Although not specifically depicted, it is noted that a truck trailer container (discussed above) can also be used instead of the shipping container 112, and an apparatus that includes the truck trailer container along with some or all of the elements, components and/or features as those discussed below (and in the specific embodiments referenced above) is within the possession of the inventor(s). For example, a rigid truck trailer container can be combined with the same vertical braces, retainers and bulkhead panels that are described herein.

System 110 includes a rigid shipping container 112, and has three vertical walls 114, 116, 118, a horizontal floor (120), an open end with doors 122, 124 that are proximate the open end, which swing on hinges (not shown) between open and closed (shut) positions, so that the open end of the shipping container can be closed, and the shipping container configured in a closed position. This particular system 110 also includes a sleeve 126 that is described herein. Sleeve 126 has a flexible, substantially planar member 134 that may also be referred to as a flexible vertical sleeve side wall (panel) 134, which is a flexible wall (panel) extending along the length of the sleeve 126. Sleeve 126 also has another substantially planar member 136, also referred to as a flexible vertical sleeve side wall (panel) 136, which is a flexible wall (panel) extending along the length of the sleeve 126. The sleeve also has a floor 171, which has lengthwise edges that adjoin and correspond to the lengthwise lower edges of the vertical sleeve side walls (panels) 134, 136. The sleeve 126 also has a flexible rear vertical wall (panel) 138 disposed between and perpendicular to the two vertical side walls (panels) 134, 136. The sleeve also has a flexible front vertical wall (panel) 128, which includes a portion 130 that extends above the upper edges of the other three flexible walls (panels) 134, 136, 138, and this portion 130 operates as a flap, and certain embodiments includes straps 142 for securing the flap over the bulkhead assembly (discussed below).

Flexible front vertical wall (panel) 128 of sleeve 126 includes, in this system embodiment, two apertures 132 and 133. A portion of flexible container slurry discharge valve 156 protrudes (when the system is assembled) through aperture 132, and a portion of flexible container fluid inlet valve 157 protrudes (when the system is assembled) through aperture 133. Both valves 156 and 157 are depicted in representational illustrative, non-detailed form in FIG. 8. Embodiment 110 of the shipping container apparatus also includes a flexible container 154, which has an aperture 158 for granular product loading and an optional aperture for an air vent (not illustrated). It is noted that the air vent can be located in places other than at the top of the flexible container including, for example, a location next to slurry discharge valve 156. Fluid inlet and slurry outlet conduits are not depicted in this embodiment, but would be attached to fluid inlet valve 157 and slurry discharge valve 156, as in previous embodiments.

Also included in the specific system 110 depicted in FIG. 8 is flexible cargo net 160, which can be secured at a diagonal orientation to secure the flexible container during transportation. In certain embodiments, the cargo net inhibits upward movement of the flexible container within the rigid container 112 when the rigid container is being transported on a ship and experiences severe wave action, causing the flexible container to roll forward and backward and up and down. The flexible cargo net 160 is shown in FIG. 8 as part of an unassembled exploded view of the various components of the specific apparatus 110, but it will be recognized that the cargo net is to be placed so that it secures the flexible container, and has, for example, one edge (the lower edge, which is horizontal and closer to the bulkhead assembly) secured proximate either the top of the bulkhead assembly 168 or midway across the inside of the bulkhead assembly, and can optionally be secured on the inside surface of the flexible front vertical sleeve wall 128. The upper edge of the cargo net can be secured by cords (not shown), e.g., one cord that ties the cargo net to one of the sides of the rigid container (e.g., inside of side wall 116) and a second cord that ties the cargo net to another side of the rigid container (e.g., inside of side wall 114). As noted elsewhere herein, the cargo net can be either affixed to the sleeve, or it can form an integral part of the sleeve, e.g., being sewn together with the sleeve or otherwise affixed or adjoined along one edge (in certain embodiments the lower edge) to the sleeve. As depicted in the drawings, the cargo net is rectangular, but it is contemplated that a cargo net in which the side farthest away from the doors (e.g., the free or unaffixed side) has a width that is smaller than the width of the cargo net closest to the doors.

The specific apparatus 110 depicted in FIG. 8 also includes air pillows, which in certain embodiments function as cushions against the upward movement of the flexible container against the inside of the top “lid” (not shown) of the rigid container. At least one of the air pillows 162 can be placed on top of the cargo net 160, described above. Other air pillows 164, 166, can be placed directly on either side of the upper surface of the flexible container, and those other air pillows also serve as cushions to the upward movement of the flexible container, and also tend to inhibit any rolling movement of the flexible container, e.g., toward and away from the bulkhead assembly. In certain embodiments, the air pillows have valves (not shown) where pressurized air can be introduced to the interior of each air pillow, and such air can also be released, e.g., upon arrival of the shipping container apparatus 110 to its destination.

Also depicted in FIG. 8 is a specific bulkhead assembly 168 which includes two vertical braces 170, 172, and three horizontal bulkhead panels. The vertical braces and the horizontal bulkhead panels are described in greater detail in assignee's U.S. patent application Ser. No. 12/______, claiming priority from provisional patent application Ser. No. 61/115,794, filed Nov. 18, 2008, and Ser. No. 61/215,706, filed May 8, 2009 previously incorporated herein by reference. The specific horizontal panels in apparatus 110 (which can also be referred to as horizontal reinforcement members) include an upper bulkhead panel 190a, an intermediate bulkhead panel 190b and a lower bulkhead panel 102. The lower panel includes apertures through which respective extending portions of the flexible container slurry discharge valve 156 and fluid inlet valve 157 can pass.

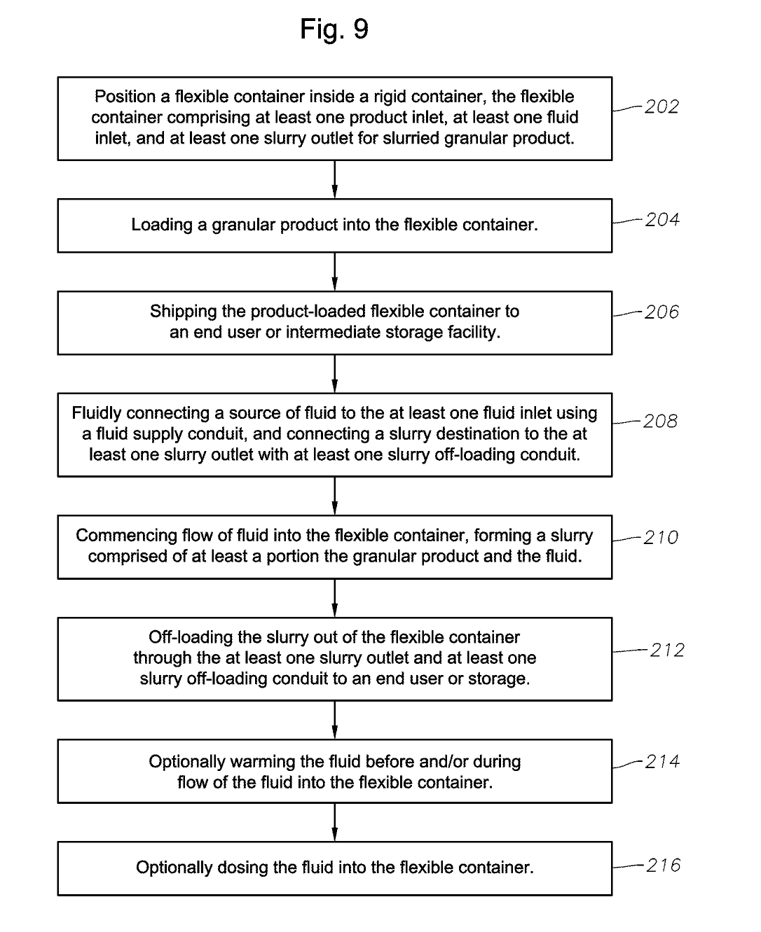

FIG. 9 illustrates a logic diagram of one method within the disclosure. In this specific method, box 202 indicates that a flexible container is first positioned inside a rigid container, the flexible container comprising at least one product inlet, at least one fluid inlet, and at least one slurry outlet for slurried granular product. As box 204 illustrates, the next step is to load a granular product into the flexible container. As box 206 illustrates, the next step is to ship the product-loaded flexible container to an end user or intermediate storage facility. As illustrated in box 208, then fluidly connect a source of fluid to the at least one fluid inlet using a fluid supply conduit, and fluidly connect a slurry destination to the at least one slurry outlet with at least one slurry off-loading conduit. As box 210 indicates, commence flow of fluid into the flexible container, forming a slurry comprised of at least a portion the granular product and the fluid. According to box 212, off-load the slurry out of the flexible container through the at least one slurry outlet and at least one slurry off-loading conduit to an end user or storage.

As illustrated in box 214, the method may include optionally warming the fluid before and/or during flow of the fluid into the flexible container. Warming may include heating the fluid using direct and/or indirect heat transfer methods. Indirect heat transfer may be accomplished using, for example, a fluid/fluid heat exchanger, such as co-current, counter-current, and cross-flow heat exchangers, where heat is transferred through walls of tubes through which a heated fluid traverses, such as steam or a heat transfer fluid such as a heated glycol solution. Shell and tube heat exchangers may be used, as may fin-tube heat exchangers. Heat exchangers are well-known in the materials processing industries, and need no further explanation here. The methods and systems contemplated herein may also cool the fluid before it enters the flexible container, if desired. Optionally, the slurry may be cooled or heated during off-loading using similar heat exchangers. Direct heat exchange involves actually contacting the material to be heated (or cooled) with another material. For example, water to be used as the fluid may be directly contacted with steam to form heated water, which is a combination of the feed water and the steam. The skilled operator or designer will determine which system and method is best suited for a particular off-loading operation to achieve the highest efficiency, safest, and environmentally sound off-loading operation without undue experimentation.

Also, as indicated in box 216, the method may optionally include dosing the fluid into the flexible container. By “dosing” is meant that the fluid flows into the flexible container in a regular or irregular pattern of high and low flow rates. For example, a regular flow pattern might comprise flowing 100 gallons per minute of water into the flexible container for 10 seconds, and alternating with flow of 25 gallons per minute of water for 20 seconds. Numerous variations are and may be contemplated by those skilled in the art, and all are considered within the scope of the term “dosing”.

Various additives may be added to the fluid before it enters the flexible container, and/or the slurry after it leaves the flexible container. Some examples might include, but are not limited to, flavors, flow modifiers, antioxidants, anti-caking additives, and the like. The amount of each additive to add to the fluid and/or slurry would be within the skill of the artisan, however, care should be taken not to adversely affect the flexible material of the flexible container.

At least one specific embodiment includes a shipping container apparatus, comprising (including): a rigid shipping container having at least a floor, a first side wall with a first side wall inner surface, a second side wall with a second side wall inner surface and an open end; a flexible container disposed within the rigid shipping container; a bulkhead assembly interposed between the flexible container and the open end of the rigid shipping container; and a flexible sleeve. Suitable bulkhead assemblies are disclosed in assignee's U.S. patent application Ser. No. 12/______, filed November ______, claiming priority from provisional patent application Ser. No. 61/115,794, filed Nov. 18, 2008, and Ser. No. 61/215,706, filed May 8, 2009 previously incorporated herein by reference.

In at least one specific embodiment, the shipping container apparatus identified above, or elsewhere herein, comprises (includes) a rigid container having: (i) a container floor that includes a substantially planar rectangular member with a substantially planar and substantially rectangular inner surface; (ii) a first container side wall that includes a substantially planar rectangular member with a corrugated inner surface (e.g., that includes multiple sub-surfaces each having at least three different planar orientations); (iii) a second container side wall that includes a substantially planar rectangular member with a corrugated inner surface (e.g., that includes multiple sub-surfaces each having at least three different planar orientations); and (iv) a container back-end wall that includes a substantially planar rectangular member with a corrugated inner surface (e.g., that includes multiple sub-surfaces each having at least three different planar orientations), wherein the inner surfaces of the floor, first and second side walls and end wall are disposed together to define an interior of the rigid container having an inside container surface.

In at least one specific embodiment, the shipping container apparatus identified above, or elsewhere herein, comprises (includes) a flexible sleeve that includes a laminated composite sheet composed of at least three individual sheets laminated together, which sleeve is removably disposed inside the rigid metallic container, which sleeve is disposed against the inside container surface, and which sleeve includes: (i) a flexible sleeve floor (floor panel) that includes a substantially planar and substantially rectangular member which is disposed substantially against the inner surface of the container floor; (ii) a flexible first sleeve side wall (panel) which includes a substantially planar and substantially rectangular member which is disposed substantially against the inner surface of the first container side wall (panel); (iii) a flexible second sleeve side wall (panel) which includes a substantially planar and substantially rectangular member which is disposed substantially against the inner surface of the second container side wall (panel); and (iv) a flexible sleeve end wall (panel) which includes a substantially planar and substantially rectangular member which is disposed substantially against the inner surface of the container back-end wall (rear panel).

Although only a few exemplary embodiments have been described in detail above, those skilled in the art will readily appreciate that many modifications are possible in the exemplary embodiments without materially departing from the novel teachings and advantages of systems, kits, and methods described herein. Accordingly, all such modifications are intended to be included within the scope of this invention as defined in the following claims. In the claims, no clauses are intended to be in the means-plus-function format allowed by 35 U.S.C. §112, paragraph 6, unless “means for” is explicitly recited together with an associated function without any structure being recited. “Means for” clauses are intended to cover the structures described herein as performing the recited function and not only structural equivalents, but also equivalent structures.

1. A method of shipping and off-loading a granular product, comprising:
a) loading a granular product into a flexible container, the flexible container positioned inside of a shipping container, the flexible container comprising at least one product inlet, at least one fluid inlet, and at least one slurry outlet for slurried granular product, the flexible container comprising at least one expandable material and at least one containment material;
b) shipping the product-loaded flexible container to an end user or intermediate storage facility using the shipping container; and
c) off-loading the granular product from the product-loaded flexible container, wherein the off-loading comprises fluidly connecting a source of fluid to the at least one fluid inlet using a fluid supply conduit, commencing flow of fluid into the flexible container, forming a slurry comprised of at least a portion the granular product and the fluid, and routing the slurry out of the flexible container through a slurry off-loading conduit.

2. The method of claim 1 wherein the fluid is substantially water.

3. The method of claim 1 wherein the container is prevented or deterred from collapsing during off-loading.

4. The method of claim 1 further comprising controlling storage conditions of the granular product prior to loading into the flexible container.

5. The method of claim 1 further comprising controlling processing of the granular product prior to loading into the flexible container.

6. The method of claim 5 wherein the controlling processing comprises controlling refining of the granular product, wherein the granular product is granulated or powdered sugar.

7. The method of claim 1 wherein the connecting comprises using quick-connect connectors.

8. The method of claim 1 further comprising warming the fluid prior to commencing flow of fluid into the flexible container.

9. The method of claim 1 further comprising warming the fluid during flow of the fluid into the flexible container.

10. The method of claim 1 wherein the flow of fluid into the flexible container comprises dosing the fluid into the flexible container.

11. A method of off-loading a granular product from a flexible container, comprising:
a) fluidly connecting a source of fluid to a flexible container having granular product therein, the flexible container having at least one fluid inlet connection;
b) fluidly connecting a destination for slurried granular product to the flexible container, the flexible container having at least one slurry outlet; and
c) commencing flow of fluid into the flexible container and allowing slurried granular product to controllably flow out of the flexible container through the slurry outlet to the destination.

12. The method of claim 11 wherein the fluid is substantially water.

13. The method of claim 11 wherein the flexible container is prevented or deterred from collapsing during off-loading.

14. The method of claim 11 wherein the connecting comprises using quick-connect connectors.

15. The method of claim 11 further comprising warming the fluid prior to commencing flow of fluid into the flexible container.

16. The method of claim 11 further comprising warming the fluid during flow of the fluid into the flexible container.

17. The method of claim 11 wherein the flow of fluid into the flexible container comprises dosing the fluid into the flexible container.

18. A system or kit for shipping and off-loading granular products, the system comprising:
a) a flexible container comprising at least one granular product inlet, at least one fluid inlet, and at least one slurry outlet;
b) first and second conduits, the first conduit routing a fluid into the flexible container and positioned to slurry the granular product after reaching an off-loading point, the second conduit routing slurried granular product out of the flexible container during off-loading; and
c) means for deterring collapse of the flexible container during off-loading of the slurried granular product.

19. The system or kit of claim 18 wherein the flexible container is substantially seemless.

20. The system or kit of claim 18 wherein said means for deterring collapse are fasteners selected from one or more snaps, loops, hook and loop fasteners, and combinations thereof, securely attached to an external surface of the flexible container in a fashion so that the fasteners are able to engage in a cooperative, supporting fashion with a rigid container into which the flexible container has been placed, thereby substantially deterring collapse of the flexible container.
